(19) United States
(12) Patent Application Publication
(10) Pub. No.: US 2001/0037635 A1
(43) Pub. Date: Nov. 8, 2001

(54) Crop lifter

(76) Inventor: Joseph R. Figliuzzi, Kelliher, MN (US)

Correspondence Address: DAVID KIEWIT, 5901 THIRD ST SOUTH, ST PETERSBURG, FL, 33705, US

(21) Appl. No.: 09/891,958

(22) Filed: Jun. 26, 2001

Related U.S. Application Data
(63) Continuation-in-part of application No. 09/515,604, filed on Feb. 29, 2000.

(51) Int. Cl. A01D 34/18

(52) U.S. Cl. 56/119; 56/312

(57) ABSTRACT

A crop lifter is described that combines the lifting ability of a conventional lifter with the sickle protecting qualities of a sickle guard. Crop-lifting surfaces in the combination lifter and guard extend from a forward end of an extended guard finger to a rearward end located substantially above a sickle knife slot and substantially rearward of a leading edge of the knife slot. This arrangement has been found to reduce crop loss. Some versions of the combination lifter and guard include a crop-holding surface that prevents crop loss by preventing grain from spilling backward or off the front end of a cutter bar.

### CROSS REFERENCE TO RELATED APPLICATIONS

This application is a continuation-in-part of U.S. Ser. No. 09/515,604, filed Feb. 29, 2000.

### BACKGROUND OF THE INVENTION

1. Field of the Invention

This invention relates to sickle guards and to grain and crop lifters for all types of harvesters including combines, swathers, mowers, and the like.

2. Background Information

There has long been a need for a crop lifter of simple construction that would enable tangled or fallen grain crops to be retrieved with a minimum of loss. In the past, conventional crop lifters have been elongated add-on attachments that have proved inadequate for a variety of reasons. The conventional lifters in use today oftentimes cause more grain and crop loss than would be the case if they were left off the implement. The distance between the front end of most lifters and the harvester platform is so great that much of the crop is lost or damaged before the crop reaches the cutter bar. Grain that should be carried into the machine is instead shaken off and falls to the ground before the stalks reach the sickle knives.

All prior art shows that conventional lifters are mounted so as to extend considerably forward of the sickle knife guards. This creates many problems including frequent breakage associated with the lifters' tendency to dig into the ground on uneven terrain. This is the case even with crop lifters that are not intended to ride on the ground. Another problem with lifters which extend considerably forward of the sickle guards is the loss and breakage of lifters during turning operations when the forces are greatest on the leading edges of the lifters. The longer the lifters, the greater the force.

Some prior art lifters are attached to the cutter bar platform itself Devices of this sort are taught in the patents issued to M. P. Babcock (U.S. Pat. No. 2,960,814), A. D. Braasch et. al (U.S. Pat. No. 1,815,491), W A. Reimer (U.S. Pat. No. 2,748,230). Other prior art lifters are attached to the sickle guard, such as those taught by V. L. Hunter (U.S. Pat. No. 4,702,0641), and E. Beltz (U.S. Pat No. 2,394,838). Still other such devices are attached to both the cutter bar platform and the sickle guard. Devices of this sort are taught by W. Gaterman, U.S. Pat. No. 791,022), W. M. Wadleigh (U.S. Pat. No. 1,250,251), W. I. Kenison (U.S. Pat. No 3,163,9751), Shumacher, II et al. (U.S. Pat No. 3,834,1391), and Stomacher II et. al. (U.S. Pat. No. 3,742,690).

### BRIEF SUMMARY OF THE INVENTION

Accordingly, several objects and advantages of the present invention are:

(a) to provide a new crop lifter that combines the lifting ability of a lifter with the cutting action of a sickle guard.

(b) to provide a crop lifter and sickle guard combination having a one-piece construction.

(c) to provide a crop lifter having a lifting surface engaged with the point or front of the sickle guard finger and following an angular upward and rearward direction from that point.

(d) to provide a crop lifter of reduced length that will pick up fallen crops with the assurance that the device will not run into the ground.

(e) to provide a crop lifter that is convenient to use. The crop lifter is installed on a harvester no differently than a conventional sickle guard.

(f) to provide a crop lifter that lifts the crop only when the plants are close to the cutter bar, thus insuring that any shattered grain will fall into the harvesting machine and not on the ground.

(g) to provide a crop lifter that eliminates shattering due to turning forces or vibration.

(h) to provide a crop lifter having an easily attached or removed lifting tine that allows the apparatus to be used with a variety of crops.

(i) to provide a crop lifter which is sturdily built to withstand or reduce damage from rocks.

Although it is believed that the foregoing recital of features and advantages may be of use to one who is skilled in the art and who wishes to learn how to practice the invention, it will be recognized that the foregoing recital is not intended to list all of the features and advantages. Moreover, it may be noted that various embodiments of the invention may provide various combinations of the hereinbefore recited features and advantages of the invention, and that less than all of the recited features and advantages may be provided by some embodiments.

### BRIEF DESCRIPTION OF THE SEVERAL VIEWS OF THE DRAWING

FIG. 1 is a perspective elevational view of a paired finger embodiment of the invention.

FIG. 2 is a perspective elevational view of a single finger embodiment comprising a crop holding cleat and a replaceable crop lifting tine.

FIG. 3 is a perspective elevational view of a double finger embodiment having flexible and replaceable lifting tines.

FIG. 4 is a perspective elevational view of a one-piece construction plate-type apparatus of the invention paired with a conventional sickle guard on a common mounting pad.

### DETAILED DESCRIPTION OF THE INVENTION

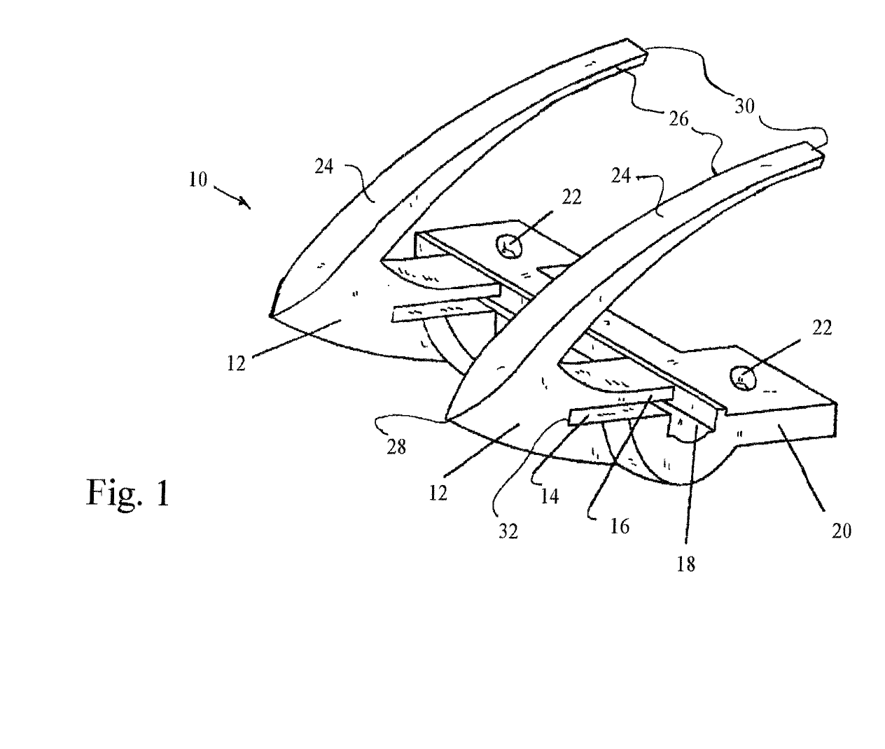

A crop lifter 10 of the invention typically has a knife slot 12 formed in a body portion 14 of the lifter 10 and an upper lip 16 adapted to extend over a conventional sickle knife 15 when the apparatus 10 is installed on an agricultural implement. Rearward of the upper lip 16 is a cutter bar groove 18 which acts as a seat for the reciprocating sickle knife bar. Rearward of the groove 18 is a mounting pad portion 20 having one or more vertical throughholes 22 used for attaching the crop lifter 10 to the harvester's cutting platform 25 by well known means such as bolts 23. Crop-lifting surfaces 24, in the embodiment depicted in FIG. 1, are provided by tines 26 that are integral to the crop lifter body 14 and extend from a forward end 28 of the apparatus, where the body 14 and lifting tine 26 merge to a rearward end 30 located substantially above the knife slot 12 and substantially rearward of a leading edge 32 of the knife slot 12.

In preferred embodiments of the invention, the rearward end 30 of the lifting surface 24 stands above the knife slot 12 by a distance that lies in a range between one half and three quarters of the distance between the leading edge of the knife slot 12 and the forward edge or face of the mounting pad 20—i.e., by one half to three quarters of the maximum width of a sickle knife 15 installable in the slot. Moreover, it is preferred that the forward end 28 of the apparatus 10 extends forward of the leading edge 32 of the slot 12 by at least the maximum knife width. Tests of several different combinations of forward extent and lifter height indicate that a preferred ratio of height to length is about one to three—e.g., three inches of rise in a length of nine inches. Although these tests were performed with a variety of different shapes and sizes of lifters, the preferred 1:3 ratio has been found to allow a smooth, uninterrupted flow of crop plants while raising them far enough so that reel batts or reel batt fingers can sweep them into the harvester.

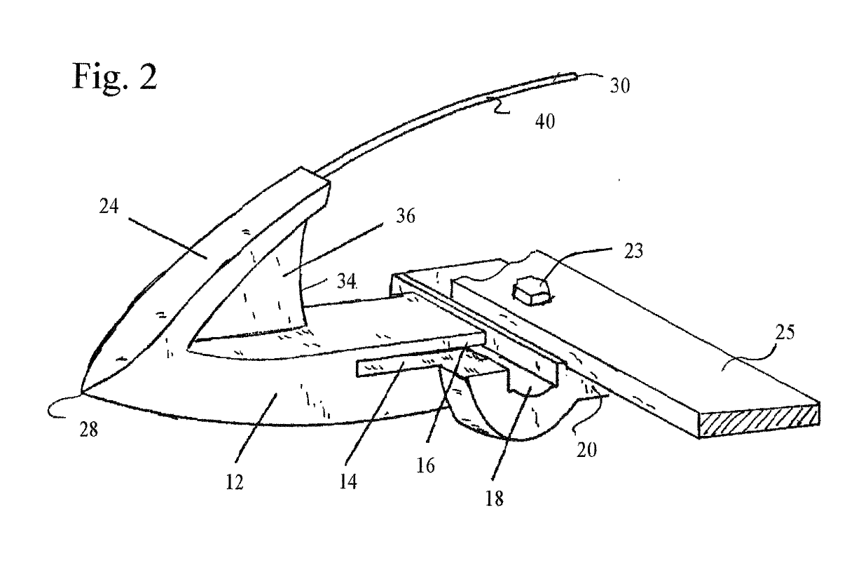

Some embodiments of the crop lifter 10 provide a crop-holding surface 34 that may be the rearward end of a gusset or cleat 36 or that may be the rear surface of a lifter plate 38. In the embodiment depicted in FIG. 2, for example, the cleat 36 provides additional support for the lifting tine 26, prevents the cutter from being clogged by crop material that might otherwise become lodged behind the tine 26, and prevents crop loss by holding the crop in place, thereby preventing grain from spilling backward or off the front end of the cutter bar 25.

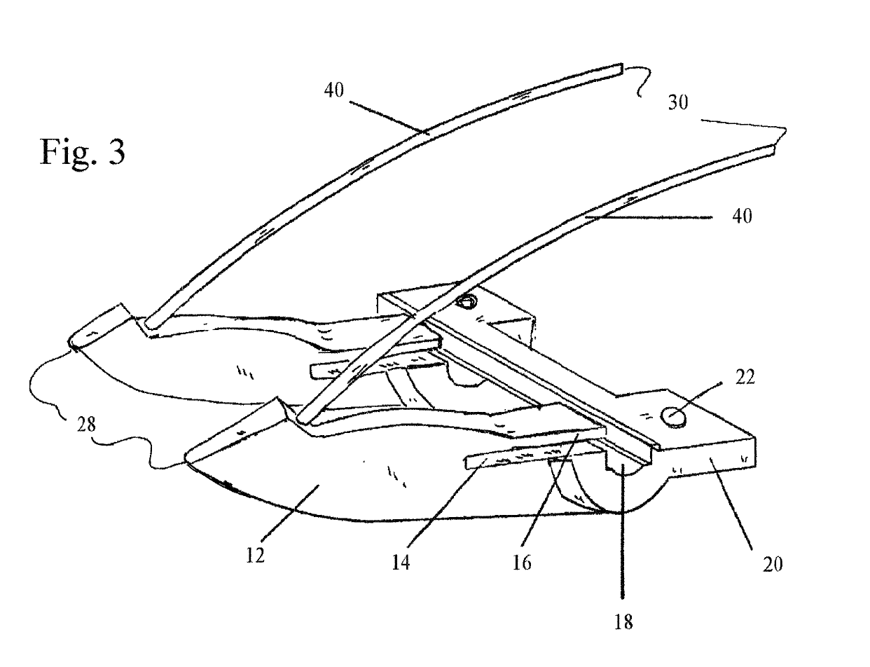

Embodiments having a tine, or other lifting surface that is integrally formed with the body of the apparatus are generally strongest. Hence, the user with an abundance of rocks in his fields would probably prefer the sturdier one-piece construction models. Other users, however, may want to change the length or spacing along the cutter bar of the lifting elements. These users may prefer embodiments, such as those shown in FIGS. 2 and 3, that have easily installed and removed flexible tines 40. A wide variety of approaches may be used for attaching flexible tines 40 to the body 14 of the lifter 10. These include, but are not limited to the combination of a threaded end on a tine 40 and a threaded mounting hole in the body 14, and a set screw threaded into the body 14 so as to impinge upon and capture the tine 40 (which may have a flattened surface on the end inserted into the hole in the body so as to retain the tine in a fixed position so that it can not twist about its axis). Moreover, as depicted in FIG. 2, one can have a composite tine that is partially integrally formed with the body 14 and that is partially a flexible detachable tine. It should be clear to those skilled in the arts that if flexible tines were found to provide the best lifting performance, and if the user did not plan to reconfigure the harvesting arrangement, the flexible tines could easily be soldered or adhered to the body of the lifter.

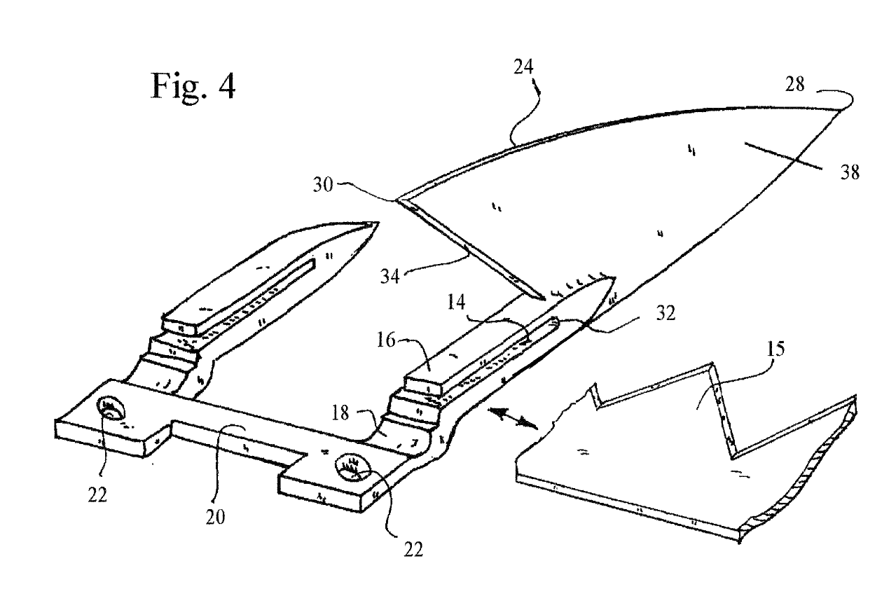

The use of easily removed flexible tines is not the only approach available for adjusting the spacing along the cutter bar between tines or other lifting surfaces in order to accommodate specific requirements of different grain crops. Because the crop lifter 10 of the invention is directly bolted to the cutter bar 25 as a replacement for a conventional sickle guard, one can adjust the spacing between lifters by installing lifters to replace only some of the conventional sickle guards on a cutter bar. For example, a single tooth embodiment (e.g., as shown in FIG. 2) of the crop lifter can be installed side-by-side with conventional sickle guards. Moreover, one can construct attachable items comprising a lifter combined with a non-lifting sickle guard, as depicted in FIG. 4.

Turning now to FIG. 4, one finds a preferred embodiment having a one-piece construction in which a lifter plate 38 is welded onto one of the teeth of a conventional paired cutter guard body. The plate 38 provides both a lifting surface 24 and a crop-retaining surface 34 so that the plate lifts the crops, separates the crop, prevents any plants from falling forward, and prevents wrapping of crop. Those skilled in the art will appreciate that although crop lifters of the invention have generally been made from steel, there is no requirement that they be steel, or even that they be metallic. Various plastic materials, particularly those that are fiber-reinforced, could also be used to make a lifter of the invention.

The crop lifter of the invention has many advantages over a conventional crop lifter that is merely a lifting device attachment. Notable among these are:

a) It reduces crop loss by reducing the length of the lifting tine. Grain normally lost through shattering when using conventional lifting tines is saved with the inventive crop lifter.

b) Vibration is eliminated with one-piece construction and turning forces have no effect on the crop lifter.

c) Crop loss is considerably reduced because the tines of the combination lifter and guard lean backward from the point of the elongated sickle guard and do not protrude forward of the sickle guard as found in conventional crop lifters.

d) Because the lifter tine design is incorporated as a single unit with the sickle guard, running the lifter/guard into the ground is avoided altogether, thereby eliminating breakage of sickle guards, sickle, cutters, and the harvester itself.

e) It permits installation identical to conventional sickle guards.

f) It provides strong and rigid protection against rocks and other obstructions.

Although the description above contains much specificity, these should not be construed as limiting the scope of the invention but merely providing illustrations of-some of the presently preferred of this invention. For example, the crop lifter fastening means can have other ways of fastening the lifting tines other than those described above. The tines themselves can be longer, shorter, broader, higher, and angled differently. The tines can be of spring steel, plastic, or any suitable material. The lifter) cutter guard can also be of varying lengths, for example, to suit particular crops. Thus the scope of the invention should be determined by the appended claims and their legal equivalents, rather than by the examples given.

1. An apparatus for lifting crops and for protecting a crop-cutting sickle knife that is adapted to reciprocate along, and in front of, a cutter bar platform, the sickle knife having a predetermined width, the apparatus comprising:
a base portion comprising a sickle knife slot having a leading edge, the sickle knife slot having an upper lip adapted to extend over a top of the sickle knife, the sickle knife slot adapted to receive the sickle knife therein;
a sickle knife guard finger portion projecting forward of a leading edge of the sickle knife slot;
a crop lifting surface portion extending upwards and rearwards from a forward end of the finger portion to a rear end that is disposed both at least one half of the predetermined width above a top of the sickle knife slot, and rearwards of the leading edge of the sickle knife slot; and
a mounting pad portion extending rearward of the sickle knife slot, the mounting pad portion having at least one throughhole extending vertically therethrough to adapt the apparatus for attachment directly to the cutter bar platform.

2. The apparatus of claim 1 wherein the crop lifting portion comprises a tine integrally formed with the sickle knife guard finger portion.

3. The apparatus of claim 1 wherein the crop lifting portion comprises a flexible tine detachably connected to the forward end of the sickle guard finger portion.

4. The apparatus of claim 1 wherein the sickle guard finger portion extends forward of a leading edge of the sickle knife slot by at least the predetermined width.

5. The apparatus of claim 1 further comprising a crop-holding portion having a crop-holding surface extending between the sickle knife guard finger portion and the crop lifting portion.

6. The apparatus of claim 1 wherein the crop-lifting portion comprises a plate, an upper surface of the plate comprising the crop-lifting surface, a rear surface of the plate comprising a crop-holding surface.

7. An apparatus for lifting crops and for protecting a crop-cutting sickle knife that is adapted to reciprocate along, and in front of, a cutter bar platform, the sickle knife having a predetermined width, the apparatus comprising:
a base portion comprising a sickle knife slot having a leading edge, the sickle knife slot having an upper lip adapted to extend over a top of the sickle knife, the sickle knife slot adapted to receive the sickle knife therein;
a sickle knife guard finger portion extending forward of a leading edge of the sickle knife slot by at least the predetermined width;
a crop lifting surface portion extending upwards and rearwards from a forward end of the finger portion to a rear end that is disposed at least one half of the predetermined width above a top of the sickle knife slot; and
a mounting pad portion extending rearward of the sickle knife slot, the mounting pad portion having at least one throughhole extending vertically therethrough to adapt the apparatus for attachment directly to the cutter bar platform.

8. The apparatus of claim 7 wherein the rear end of the crop-lifting surface is rearwards of the leading edge of the sickle knife slot.

9. The apparatus of claim 7 wherein the crop lifting portion comprises a tine integrally formed with the sickle knife guard finger portion.

10. The apparatus of claim 7 wherein the crop lifting portion comprises a flexible tine detachably connected to the forward end of the sickle guard finger portion.

11. The apparatus of claim 7 further comprising a crop-holding portion having a crop-holding surface extending between the sickle knife guard finger portion and the crop lifting portion.

12. The apparatus of claim 7 wherein the crop-lifting portion comprises a plate, an upper surface of the plate comprising the crop-lifting surface, a rear surface of the plate comprising a crop-holding surface.

13. A method of installing a crop lifter on an agricultural implement comprising a sickle bar, the sickle bar comprising a sickle knife, a cutter bar platform, and a predetermined number, greater than one, of sickle guards, each of the sickle guards comprising at least one finger portion extending forward of the sickle knife, each of the sickle guards attached to the cutter bar platform by at least one bolt, each of the bolts extending through a vertical throughhole in the cutter bar platform, the method comprising the steps of:
removing a selected one of the sickle guards;
replacing the selected removed sickle guard with the crop lifter by attaching the crop lifter to the cutter bar so that a lower portion of the crop lifter is below the sickle knife, an upper lip portion of the crop lifter is above the sickle, and a crop lifting edge portion of the crop lifter extends above the sickle by at least a width of the sickle and bolting the crop lifter to the cutter bar platform.

14. The method of claim 3.0 wherein the steps of removing and replacing are repeated a plurality of times whereby a plurality of the sickle guards are replaced with a corresponding plurality of crop lifters.
